(19) United States
(12) Patent Application Publication
(10) Pub. No.: US 2026/0195469 A1
(43) Pub. Date: Jul. 9, 2026

(54) RECOMMENDATION AND REMEDIATION OF ROLE-BASED ACCESS CONTROL POSTURES FOR IDENTITIES

(71) Applicants: Subramanian Rama, Irving, TX (US); Suraj Ranganath, Bangalore (IN); Dalwinderjeet Grewal, Cedar Park, TX (US); Kush Ojha, Thane (IN); Anish Raghavendra, Bangalore (IN); Vishesh Bansal, Gurgaon (IN); Ankush Deep, Oakland, CA (US)

(72) Inventors: Subramanian Rama, Irving, TX (US); Suraj Ranganath, Bangalore (IN); Dalwinderjeet Grewal, Cedar Park, TX (US); Kush Ojha, Thane (IN); Anish Raghavendra, Bangalore (IN); Vishesh Bansal, Gurgaon (IN); Ankush Deep, Oakland, CA (US)

(21) Appl. No.: 19/195,207

(22) Filed: Apr. 30, 2025

Related U.S. Application Data
(63) Continuation-in-part of application No. 19/055,635, filed on Feb. 18, 2025.
(60) Provisional application No. 63/641,397, filed on May 1, 2024.
(60) Provisional application No. 63/641,385, filed on May 1, 2024.
(60) Provisional application No. 63/640,944, filed on May 1, 2024.
(60) Provisional application No. 63/640,932, filed on May 1, 2024.
(60) Provisional application No. 63/640,927, filed on May 1, 2024.
(60) Provisional application No. 63/640,926, filed on May 1, 2024.

(51) Int. Cl. G06F 21/62; G06F 21/57

(52) U.S. Cl. CPC G06F 21/6218; G06F 21/577; G06F 2221/2141

(57) ABSTRACT

An automated, analytics-driven invention that generates, validates, and orchestrates unified RBAC postures spanning cloud infrastructure, SaaS applications, and on-premise assets. The method ingests entitlement data, HRIS attributes, behavioral data, and security policy constraints to identify common access patterns, detect anomalies, and recommend consolidated roles that embody the principle of least privilege. A dual-perspective algorithm—bottom-up clustering of shared connections and top-down evaluation of organizational context—produces high-fidelity roles annotated with confidence scores. The system surfaces actionable insights such as over-entitlement, under-entitlement, segregation-of-duties conflicts, and duplicate connections, then prescribes remediation playbooks or just-in-time enforcement. By continuously comparing the current state to a dynamically computed ideal state, the invention guides enterprises toward an access model that minimizes risk, streamlines audits, and reduces administrative drag.

### CROSS-REFERENCE TO RELATED APPLICATIONS

This application is a Continuation-in-Part Utility Patent application claiming priority to U.S. patent application Ser. No., filed on Feb. 18, 2025, which claims priority to U.S. Provisional Patent Application Ser. No. 63/641,397, filed on May 1, 2024, U.S. Provisional Patent Application Ser. No. 63/641,385, filed on May 1, 2024, U.S. Provisional Patent Application Ser. No. 63/640,944, filed on May 1, 2024, U.S. Provisional Patent Application Ser. No. 63/640,932, filed on May 1, 2024, U.S. Provisional Patent Application Ser. No. 63/640,927, filed on May 1, 2024, U.S. Provisional Patent Application Ser. No. 63/640,926, filed on May 1, 2024, to which are incorporated by reference herein in their entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to computer-implemented identity and access-management systems, and more particularly to automated generation and maintenance of Role-Based Access Control (RBAC) configurations across heterogeneous computing environments.

### 2) Description of Related Art

Conventional RBAC solutions assume a small set of stable business applications and roles that change infrequently. In contemporary enterprises, however, employees, contractors, service accounts, and automated pipelines interact with cloud platforms, SaaS services, and on-premises resources that are created and retired on a daily basis. Each system expresses privileges in its own vocabulary; consequently, administrators must curate hundreds of disparate role catalogs and still cannot obtain an authoritative, up-to-date map of who can perform which sensitive actions.

Current governance tools exhibit three technical deficiencies:
Static role catalogs. Once defined, roles are seldom re-evaluated, allowing unused or excessive permissions to persist (“RBAC drift”).
Role sprawl and duplication. Slight variations in access requirements spawn overlapping or nearly identical roles, complicating audits and diluting least-privilege intent.
Siloed visibility. Connectors operate per application and do not reason about privilege combinations that span multiple systems.
Manual remediation. Periodic access reviews and ticket-driven revocation processes are labor-intensive and prone to omission.

These shortcomings hinder enforcement of least-privilege principles and complicate compliance with security standards that require demonstrable, continuous control over entitlements. The disclosed method continuously ingests entitlement data from diverse sources, correlates it with organizational context and policy constraints, and algorithmically synthesizes high-confidence roles that reflect actual usage. The system detects over-entitlement, segregation-of-duties conflicts, and other anomalies in real time, then drives automated or workflow-based remediation. By replacing static, manual RBAC administration with data-driven, self-updating role generation, the invention maintains least-privilege access while reducing operational overhead.

Modern enterprises rely on an ever-expanding constellation of cloud services, SaaS platforms, on-premises systems, and automation scripts to conduct routine business operations. Each system introduces its own identities, roles, groups, and fine-grained permissions. As employees join, depart, or shift responsibilities, the mapping between people and privileges drifts. Identities proliferate (“identity sprawl”), and individual accounts quietly accumulate access well beyond the needs of their current functions (“over-entitlement”).

The cumulative effect is a swollen attack surface in which:
Visibility is fragmented. Security teams cannot authoritatively answer the fundamental question, “Who can do what, where, and why?” across all environments.
Manual remediation does not scale. Access reviews, joiner/mover/leaver workflows, and compliance attestations consume thousands of staff-hours and still miss latent risks.
Least-privilege principles collapse. Excessive standing privileges increase the probability and blast radius of insider threats, credential-stuffing attacks, and accidental data exposure, while also violating regulatory frameworks such as PCI-DSS, HIPAA, and SOX.

A purely manual or application-specific approach to Role-Based Access Control (RBAC) therefore fails to deliver durable security or operational efficiency. A new, data-driven, organization-wide method is required—one that continuously mines entitlements, evaluates business context, and synthesizes precise roles that shrink privilege to what is strictly necessary while preserving productivity.

### BRIEF SUMMARY OF THE INVENTION

The instant invention in one form is directed to A method to discover and group permissions by analyzing the intersection of identities and the resources they actively consume, thereby eliminating redundant role definitions and connection duplication. The method integrates human resource information system data including department, job title, manager hierarchy, location, and tenure to calculate a statistical confidence score that quantifies role relevance within a peer group. The method enforces the principle of least privilege by applying tunable policy constraints (e.g., maximum privilege power versus resource sensitivity, SoD rules, behavioral usage thresholds), automatically flagging violations. The method generates role-merge and role-split recommendations based on overlap analysis and segregation-of-duties checks, ensuring that each synthesized role is internally consistent and non-redundant. An ideal role-resource graph is produced by simulating the remediation of every open finding; the system then measures and reports RBAC drift—the delta between the ideal and live graphs in real time, giving security teams a quantitative target for continuous improvement. The method exposes a risk-weighted findings engine that aggregates insight labels (outlier, over-entitled, below-threshold, unused access, duplicate connection) into holistic findings per identity, application, or business role, complete with impact explanations and remediation workflows. A machine-learning pipeline ingests organizational location, privilege envelope, and accessibility-graph features and assigns every resource a Very-Low to Very-High sensitivity tier, enabling precise risk evaluation of resources that are independent of manual tagging. The model incorporates an active-learning feedback loop whereby administrator edits to resource-sensitivity labels are stored as training data and used to retrain the classifier, yielding progressively higher accuracy without full retraining cycles. Tenant-configurable confidence thresholds allow each organization to fine-tune sensitivity and role confidence thresholds; deviations from these thresholds instantly spawn findings whose risk weights scale with the size of the deviation, ensuring that the most anomalous privileges rise to the top of remediation queues. The method operates in a zero-touch mode, requiring customers only to connect integrations; the system harvests entitlements, synthesizes RBAC, and presents prioritized recommendations without manual rule-writing unless preferred by the organization.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows a flowchart of a method of control according to the present invention.

FIG. 2 shows a confidence score equation according to the present invention.

FIG. 3 shows a flowchart for a method of prediction.

FIG. 4 shows an organization chart according to the present invention.

FIG. 5 is a sensitivity model according to an aspect of the invention.

FIG. 6 shows a flowchart showing the process of building the model of FIG. 5.

FIG. 7 shows an assumption chart of the features.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

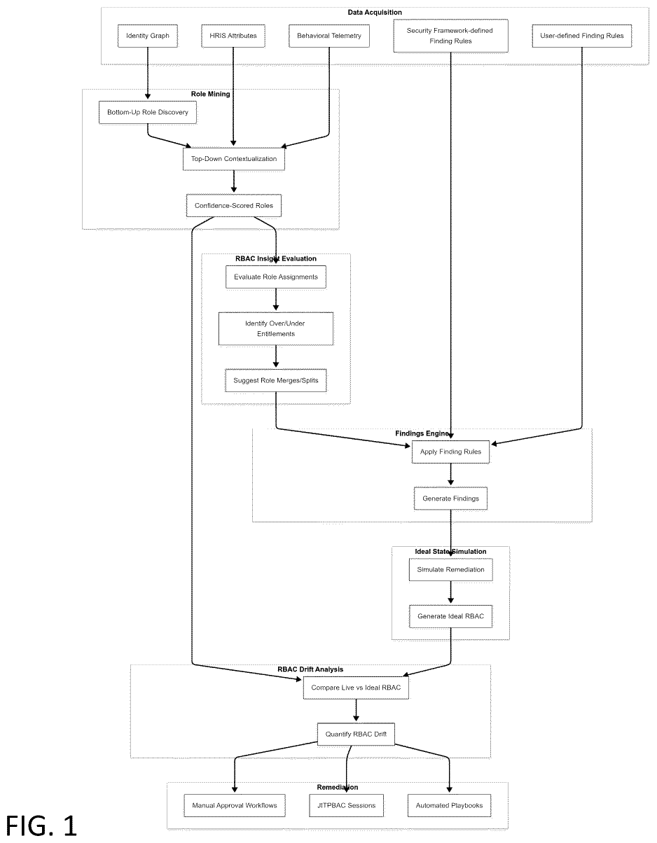

FIG. 1 shows a flowchart of a method of control according to the present invention. The flowchart shows the following:

### 1. Data Acquisition

The system ingests four complementary data streams:
Entitlement Graphs from each integrated platform (IAM policies, SaaS groups, roles, privilege grants)
HRIS Attributes providing authoritative person-to-organization relationships (department, job title, employment status)
Behavioral Telemetry such as credential usage, resource access frequency, and last-login timestamps
Policy Constraints representing vendor best practices, compliance controls, and customer-defined rules

### 2. Bottom-Up Role Discovery

For every identity, the engine enumerates its complete set of connections (logical access paths such as Okta groups, GitHub teams, AWS IAM policies). Identities that share an identical connection set are provisionally clustered; the focus then shifts from identities to connections, grouping connections visited by the same identity cohort. This two-stage matrix factorization yields unique connection groups—the skeletal roles.

### 3. Top-Down Contextualization

Each provisional role is enriched with HRIS context. The proportion of employees in a given department/job title possessing the role becomes its confidence score. Roles with 100 % coverage in the company are tagged Birthright; roles universal to a department are Department Birthright; roles confined to a manager's team become Functional; and so forth. Low-confidence roles (<25 %) trigger scrutiny for over-entitlement.

### Algorithm

### 1. Create Identity-Connection Groups

Start by identifying the set of connections each identity has, mapping the relationships between users or entities and resources. This forms the foundation for understanding access patterns across the organization.

### 2. Group Connections Shared by the Same Set of Identities

Grouping connections that are accessed by the same set of identities. This reduces redundancy, prevents role sprawl, and simplifies onboarding and role modifications. The focus is on managing connections centrally, rather than repeatedly assigning them to individual roles.

### 3. Integrate HRIS Information to Assess Role Significance

After creating roles using the bottom-up grouping approach, we integrate HRIS data, which includes information on employees'departments, job titles, tenure, manager and other organizational attributes. By combining this HRIS data with the generated roles, we can:
Determine Role Relevance: Assess whether employees in specific departments or with certain attributes should or should not have access to a particular role, based on their organizational context.
Achieve Least Privilege Access: This helps in aligning role assignments with the principle of least privilege, ensuring that employees have only the access necessary for their job functions, thereby enhancing security.

Identify Anomalies: Detect any discrepancies, such as employees having access to roles that are not relevant to their job descriptions or departments, highlighting potential security risks or misconfigurations.

### 4. RBAC Insights Evaluation and Recommendations

The engine evaluates every identity-role pairing and determines the following RBAC insights and recommendations:
Outlier—Identities are flagged as outliers if they possess access to connections unique within the organization. This can indicate misconfigurations or potential security risks.
Under-Entitlement—An identity is considered under-entitled when it lacks access to a role that all other employees sharing the same HRIS attributes (e.g., department, job title, or location) possess. This condition suggests that the identity may be missing essential access required for their role or function.
Below-Threshold Role—Using confidence scores based on HRIS data, this feature identifies roles that are rare within a particular job title or department, highlighting specialized or restricted roles. A low confidence score (default 25 %) indicates unusual or rare access assignments.
Over-Entitlement—Using the algorithm, we can identify an over-entitled employee or identity. Over-entitlement occurs when an employee has access to role(s) that are not assigned to anyone else in their peer group, which is defined by having the same job title, department, or organizational unit. This suggests that the employee holds permissions beyond what is typically required for their role or department, potentially posing a security risk or indicating an unnecessary privilege that should be reviewed. It is detected either when multiple roles assigned to one user all carry low confidence, or when role-overlap with peers is <25 %.
Role Assignment Recommendations for Joiners/Movers/Leavers—Confidence-scored roles drive automated provisioning, adjustment, or revocation workflows for joiners, movers and leavers.
Access Review Recommendations—Incorporating confidence scores derived from HRIS data into the access review process significantly enhances decision-making accuracy and efficiency. Confidence scores can be calculated by simulating approval of that review and performing RBAC role mining. By leveraging these scores, organizations can streamline access approvals and denials based on a clear, data-driven methodology. For instance, a confidence score of 100% suggests that access should be automatically approved, reflecting a high degree of certainty about the appropriateness of the role assignment. Conversely, a score below 25% indicates that access should be denied, as it suggests a low confidence in the role's relevance. Scores falling between these thresholds are flagged for deeper review, ensuring that more complex cases receive thorough examination. This approach not only optimizes the access review process but also ensures alignment with organizational policies and enhances overall security.

Role-Merge Recommendations—When significant overlap is detected between roles—particularly where multiple employees share the same access patterns—roles are recommended for merging. Agglomerative clustering merges roles whose employee sets overlap and whose combined SoD checks pass. This reduces role sprawl and simplifies access management by consolidating redundant roles.

### 5. Findings Generation and Ideal State Synthesis

### 5.1 Findings Engine

RBAC Insights produced in Step 4 and other insights derived via application extractors (e.g. MFA Missing, Unused Credentials, etc.) and User-defined insight definitions (E.g. SoDs, Privileged Connections) flows into a rule engine. Administrators—or pre-packaged security frameworks—define finding rules that combine these labels with additional signals such as resource-sensitivity tiers, behavioral telemetry (last-use timestamps, access frequency), and compliance mappings. A rule is essentially a constraint “No identity with a confidence score below 25 % may hold delete privileges on a High-sensitivity resource.” Whenever an identity or role violates any active constraint, the engine emits a Finding object that records the violator, the triggering rule, inherent risk, and a recommended remediation.

### 5.2 Simulated Remediation

To calculate the Ideal State RBAC, the system performs a dry-run in which all open findings are hypothetically remediated (e.g., excess privileges revoked, roles split or merged, MFA enforced). The entitlement graph produced by this simulation is then re-processed through Steps 2-4—bottom-up discovery, top-down contextualization, and constraint evaluation—to synthesize a fresh set of ideal roles and an “ideal” CRUD permission matrix.

### 5.3 RBAC-Drift Measurement. Divergences between Live Roles and Ideal Roles are Quantified Along Multiple Axes (Membership, Privilege Power, Resource Coverage, CRUD Operations) and Reported as RBAC drift. Dashboards and APIs Highlight the Drift Magnitude Per Identity, Role, application, and Department, Enabling Prioritization of Remediation Work

### 6. Remediation, Ideal-State Convergence, and Feedback Loop. Once Findings are Generated, the Platform Initiates Remediation Workflows Through two Complementary Channels

Automated playbooks.
Pre-approved actions—such as revoking an unused AWS policy, enforcing MFA on an Okta group, or splitting a role that violates SoD—are executed immediately via direct API calls to identity providers (Okta, Azure AD), cloud platforms (AWS IAM, GCP IAM), SaaS admin endpoints (GitHub, Jira), or ITSM tools (ServiceNow, Jira SM). Each action is logged with a cryptographic hash to provide tamper-evident audit proof.
JITPBAC sessions. For privileges that should exist only while a user is performing a narrowly defined task (e.g., emergency database patching, vendor troubleshooting), the engine initiates a
Just-In-Time Purpose-Based Access Control grant. The user (or an automation trigger) requests a short-lived “purpose” that specifies scope, duration, and constraints; upon approval, the system provisions the necessary entitlements, monitors usage, and automatically revokes them when the time window or purpose expires—eliminating standing access without delaying urgent work.
Human-in-the-loop tickets. High-impact or non-deterministic changes (e.g., removing delete privileges from a production database role) are routed to the appropriate approver—manager, application owner, or security steward—along with machine-generated context: risk rating, business justification, and least-privilege alternative. Approvers can accept, modify, or dismiss the recommendation; their decision feeds back into the model as reinforcement data. After each remediation (automatic or manual), the system re-ingests fresh telemetry from all connected integrations, updates connection-usage statistics, and re-computes role confidence, thereby producing a new live identity graph. This graph is instantly compared against the Ideal State RBAC (Section 5.2) to quantify residual drift. If drift remains above an administratively defined threshold—say, >5 % of identities with low-confidence roles—the engine automatically queues the next remediation cycle.

The result is a closed-loop control system with the following properties:
1. Continuous Alignment. Roles, privileges, and group memberships are perpetually pulled toward the simulated ideal, preventing the quiet accumulation of excess access.
2. Measurable Progress. Dashboards display real-time drift metrics (role overlap, privilege power delta, inactive-high-risk count) so risk owners can visualize convergence toward least privilege.
3. Audit-Ready Evidence. Every remediation—including the before/after privilege set and the drift delta it closed—is exported as a signed record, satisfying auditors that least-privilege posture is both enforced and provable.

Through iterative execution of this orchestration loop, the live environment asymptotically approaches the Ideal State RBAC, and any emergent deviation is automatically detected and corrected before it can mature into material risk.

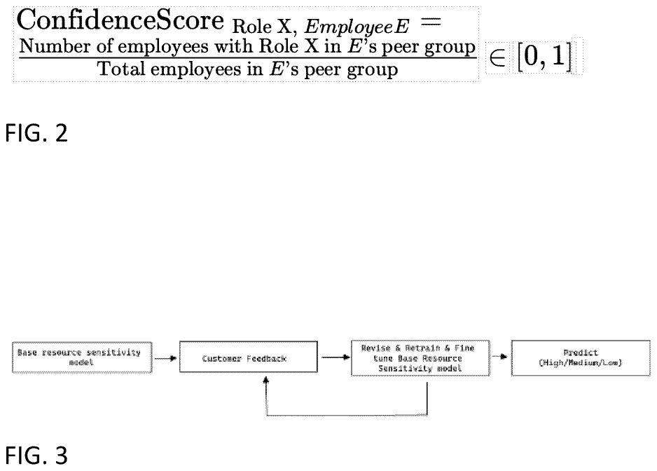

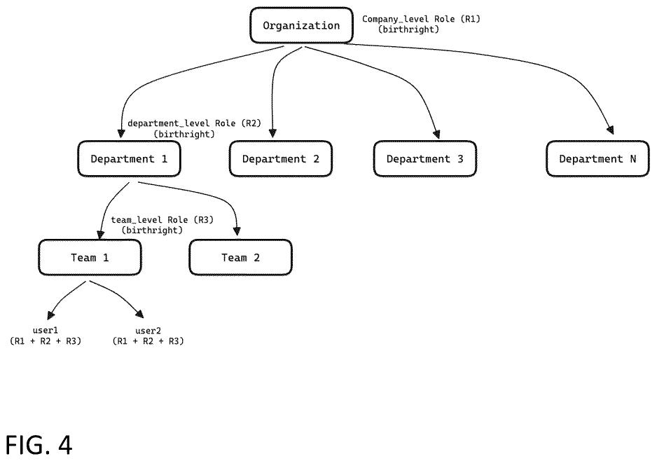

FIG. 2 shows a confidence score equation according to the present invention. FIG. 3 shows a flowchart for a method of prediction. FIG. 4 shows an organization chart according to the present invention.

### Key Concepts

### 1. Role Relevance & Confidence Score

Role relevance is a measure of how significant or common a role is for a specific department x job-title cohort within an organization. It helps determine whether a role is essential (such as “birthright” roles) or whether it requires further scrutiny due to its specialized nature or potential security implications. This relevance can inform decisions about access management, security, and organizational efficiency.
The confidence score is used to quantify role relevance. It is calculated by taking the number of employees with the same job title and department who have access to a specific role and dividing it by the total number of people with that same job title and department. The score ranges between 0 and 1. It reflects how commonly a role is assigned within a peer group and can be used to identify roles that may need closer monitoring, adjustments, or even removal.
A Confidence Score equation is shown in FIG. 2 where employee E's peer group is defined by employees who share the same department and job title as Employee E
High scores (≥0.75) identify birthright or broadly required roles, whereas low scores (≤0.25) spotlight niche or anomalous assignments that merit scrutiny or removal. Thresholds are tunable per tenant and referenced by finding-rule templates supplied for common standards (PCI-DSS, ISO 27001, NIST CSF) or by user-defined finding rules. Confidence is recomputed after every sync so role relevance adjusts as the workforce changes.

### 2. Resource Sensitivity

The value of any privilege hinges on what it can touch. To quantify that dimension, the invention furnishes a machine-learned Resource Sensitivity Model that classifies every addressable object—whether a Salesforce record, an S3 bucket, a Kubernetes secret, or a line in a firewall rule—onto a five-point ordinal scale (Very Low→Very High). The model is fully data-driven; administrators need not pre-label assets, yet they may fine-tune outcomes through active-learning feedback.

### Phase 1—Feature Extraction

1. Organizational Location (OL). Using metadata keys (e.g., AWS tags, GitHub repo paths, SaaS “owner” fields), each resource is placed on a containment path team→department→enterprise. OL encodes business-criticality implied by the owning unit.
2. Privilege Envelope (PE). All CRUD operations granted on the resource are projected into a four-bit vector, then folded into a scalar privilege-power score via the mapping Delete=3, Create/Update=2, Read=1. A database table with Update+Read therefore scores 3; a log bucket that is read-only scores 1.3.
Accessibility Graph (AG). A bipartite graph connects identities to resources through permission edges. For each resource we compute betweenness centrality, where σ denotes shortest paths. BC yields three nested visibility measures: intra-team, intra-department, and enterprise-wide.

### Phase 2—Spectral Clustering & Tier Mapping

The feature tensor F =[OL, PE, BC_team, BC_dept, BC_co] is fed to a normalized-Laplacian spectral clustering routine. The eigen-gap automatically selects k clusters; empirical testing shows k∈{3, 5}. Centroids are then aligned to semantic tiers by ranking their visibility and privilege-power medians. The mapping rule table is preserved verbatim as shown in the sensitivity tier chart of FIG. 7.

### Phase 3—Sanity Checks & Active Learning

Post-clustering heuristics correct obvious divergences (e.g., a Very High resource with >70 % company visibility is down-graded) and flag gray-zone items for analyst review. The platform then samples auto-labeled resources and solicits customer confirmation; their edits create a labelled validation set that feeds an incremental re-training pass, typically improving F1-score.

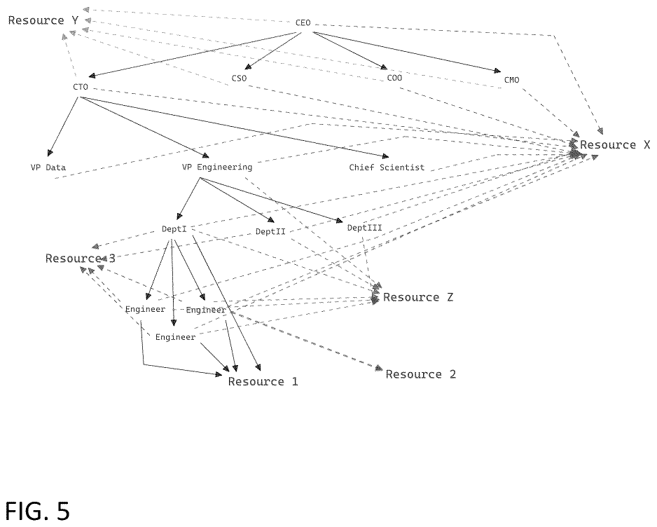

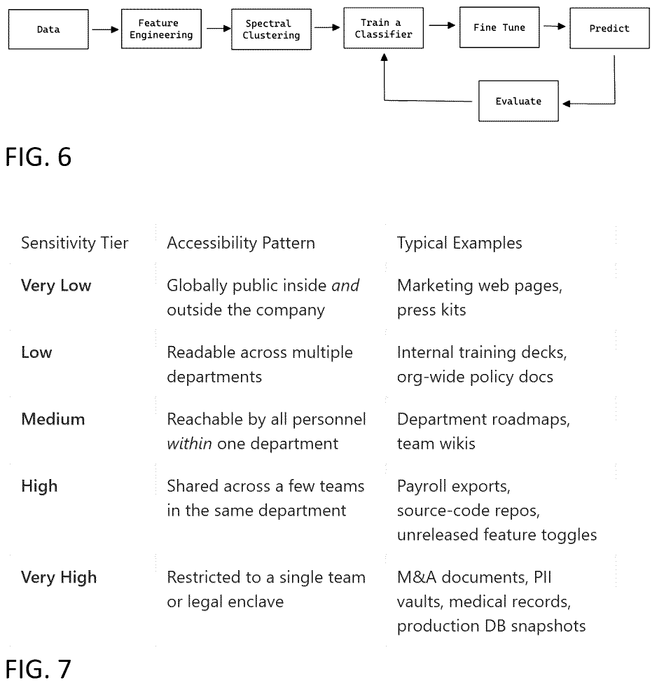

FIG. 6 shows a flowchart showing the process of building the model of FIG. 5.

Integration with Finding Rules and JITPBAC.

The finalized sensitivity tier is persisted as an attribute on each resource node within the global entitlement graph. Finding-rule templates and SoD matrices reference the sensitivity of resources directly, enabling expressions like “deny Delete on High+Sensitivity resources to contractors” Or “require multi-party approval for JITPBAC sessions that elevate into Very High Sensitivity Resources”. Because sensitivity is recomputed whenever resource metadata or accessibility changes, privileges that drift toward higher-risk resources are automatically surfaced for remediation.

3. Permissive Power (CRUD)

Permissions are normalized to Create, Read, Update, Delete and then scored:
Delete→highest privilege power
Create/Update→high privilege power
Read→low privilege power
Finding rules determine risk by reasoning over the Cartesian product of permissive power of a connection and resource sensitivity; e.g., Delete×Very-High is automatically high-risk.

### 4. Role Types

1. Birthright Role: The algorithm identifies a role as “Birthright” if it detects that every employee within the company has access to it. These roles can be automatically assigned to all users upon joining the organization.
2. Department-Level Birthright Role: A role is labeled as a “Department-Level Birthright” when the algorithm identifies that every employee within a specific department has access to it. These roles are critical for ensuring that all members of a department have the necessary permissions to perform their daily tasks, such as access to department-specific software or shared resources.
3. Job-Based Birthright Role: The algorithm categorizes a role as “Job-Based” when it is assigned to all employees within a department who share the same job title. This type of role is tailored to the specific responsibilities and needs of a particular job function, ensuring that employees have access to the tools and information necessary for their specific role, such as a project manager or data analyst within a department.
4. Functional Role: These roles are associated with specific functional areas or domains within the organization. The algorithm assigns a “Functional Role” label when all employees under a particular manager or within a specific team share the same access.
5. Location-Based Role:
A “Location-Based Role” is assigned when the algorithm detects that a role is specific to employees at a particular geographic location.

Hypothesis: If access rights are clustered by shared connection sets and validated against organizational context plus policy constraints, then the resulting RBAC configuration will (a) mirror actual business structure, (b) minimize redundant permissions, and (c) materially reduce security risk without degrading user productivity. The hypothesis further posits that continuous drift detection and on-demand orchestration can keep the live environment within an acceptable tolerance of the ideal state even as the workforce and application portfolio evolve.

FIG. 4 shows an organization chart according to the present invention.

Analysis: The hypothesis asserts that grouping by connections, rather than identities, is a superior approach for achieving efficiency and scalability in access management.

The bottom-up grouping of connections feeds directly into a top-down validation loop powered by HRIS attributes (department, job title, manager hierarchy, location, tenure) and by continuously refreshed behavioral telemetry (last-login timestamps, resource-touch frequencies, privilege-use counts). This fusion produces a multi-dimensional confidence score for every role:
a statistical measure of how strongly the role aligns with peer-group norms and with declared security constraints. Roles whose confidence falls beneath configurable thresholds are flagged as potential over- or under-entitlements, driving automated finding-rules that surface concrete, actionable findings.

Those findings in turn fuel the simulation engine that generates the Ideal State RBAC. Each finding carries a deterministic remediation payload—revocation, split, merge, Just-In-Time Purpose-Based Access Control (JITPBAC) grant, or policy correction—that is applied in silico. The resulting “clean” entitlement graph is re-mined using the same connection-centric algorithm, yielding a canonical set of high-confidence, least-privilege roles. The platform then computes RBAC Drift as a delta between live roles (post-sync) and the ideal set, quantifying both structural divergence (extra or missing connections) and risk divergence (residual violations of SoD, sensitivity constraints, or regulatory templates).

By adopting this approach, the organization can create a more streamlined and manageable access control system that effectively reduces administrative complexity, aligns with security policies, and is scalable to accommodate future growth. The hypothesis provides a clear framework for evaluating the method's effectiveness, focusing on key metrics such as efficiency, redundancy reduction, and prevention of role sprawl.

Conclusion-The invention delivers a holistic, adaptive RBAC framework that transforms raw entitlement chaos into coherent, least-privilege roles. By fusing bottom-up data mining with top-down business intelligence, it transcends the limitations of static role catalogs and manual reviews. The system's confidence-scored roles, drift analytics, and automated remediation workflows empower organizations to:
Shrink attack surfaces by revoking unused or excessive privileges.
Accelerate onboarding and off-boarding with deterministic, context-aware role assignments.
Pass audits and meet regulatory obligations with machine-generated evidence of control effectiveness.
Maintain a living alignment between security policy and operational reality—with near-zero human toil.
In a threat landscape where accesses and requirements change by the minute, this self-healing RBAC methodology offers a sustainable path to least-privilege access governance at enterprise scale.
Another aspect of the invention is a system for recommendation of RBAC (Role based access control) postures for identities across applications, assets and infrastructure in an organization

### Description

Using a unified virtualized RBAC and artificial intelligence, recommend role/group/policy/permissions postures for identities across applications, assets and infrastructure in an organization.
Another aspect of the invention is a system for modeling risks in Identity perimeters and RBAC (role-based access control) based on expressed
attributes, user behavior analytics and data classifications

### Description

Based on expressed attributes, peer group analysis, UEBA (user behavior analytics) and data classification across mapped (team members mapped to identities) as well as unmapped identities (service accounts, bot accounts), carry out risk ranking of various identities, applications/infrastructure/assets, coarse grain entitlements (roles, policies, groups, teams, permission sets, et al generally covered as RBAC-role based access control) and fine grain entitlements (underlying permissions, privileges) using Artificial Intelligence.

Another aspect of the invention is a system for Unified Virtualized risk mapped RBAC (Role based access control) model across applications, infrastructure and assets landscape in an organization

### Description

The unified, risk-mapped role-based access control (RBAC) model risks such as segregation of duties, terminations, general outliers, etc. (not limited to) across an organization's software, cloud landscapes by leveraging data science to interrogate various environments for inherent and residual entitlement risks. In addition, the model also virtualizes the role-based access control across the various environments by inferring and modeling RBAC based on data and artificial intelligence.

Another aspect of the invention is a method to determine and extract validity of controlled access granted to an identity through algorithmic processing of related employment data, relevant policies, and peer information.

### Description

This is a method to allow external systems to request real time access control decisions based on collected employee data, organizational policies, peer information, and previous decisions either from manual or accepted machine-made decisions.

Another aspect of the invention is a Machine Learning and Complex Network approach to predict resource sensitivity based on the resource accessibility in a company.

### Description

### Base Resource Sensitivity model

To build base resource sensitivity model we relied on where the resource is in the organization, how accessible is the resource and what kind of actions user can perform on the resource.

FIG. 5 is a sensitivity model according to an aspect of the invention.

FIG. 6 shows another flowchart showing the process of building the model of FIG. 5.

FIG. 7 shows an assumption chart of the features.

Base resource sensitivity model used the following data:
organizational structure,
permissions on a resource, and
resource accessibility (identify accessibility of a resource in a team, department & the company using betweenness centrality (betweenness centrality provides an indication on

how visible a resource is to the member of team/department/organization the resource appears to be part of)), to extract features. These features are then passed to spectral clustering algorithm to generate labels. Spectral clustering labels are converted into Low/Medium/High or Very Low/Low/Medium/High/Very High (depending on number of clusters detected by spectral clustering) using the assumptions in FIG. 8:
Additional checks were performed on the labels, make adjustments to the labels if required and use these labels to train our classifier. Once our base resource sensitivity classifier is ready, we present our customers with 200 labelled samples, they can either accept it or make changes to it, based on customers feedback we retrain our model to achieve higher accuracy as compare to base model.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention.

Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method to discover and group permissions by analyzing the intersection of identities and the resources they actively consume, thereby eliminating redundant role definitions and connection duplication.

2. The method according to claim 1 wherein the method integrates human resource information system data including department, job title, manager hierarchy, location, and tenure to calculate a statistical confidence score that quantifies role relevance within a peer group.

3. The method according to claim 1 wherein the method enforces the principle of least privilege by applying tunable policy constraints (e.g., maximum privilege power versus resource sensitivity, SoD rules, behavioral usage thresholds), automatically flagging violations.

4. The method according to claim 1 wherein the method generates role-merge and role-split recommendations based on overlap analysis and segregation-of-duties checks, ensuring that each synthesized role is internally consistent and non-redundant.

5. The method according to claim 1 wherein an ideal role-resource graph is produced by simulating the remediation of every open finding; the system then measures and reports RBAC drift—the delta between the ideal and live graphs in real time, giving security teams a quantitative target for continuous improvement.

6. The method according to claim 1 wherein the method exposes a risk-weighted findings engine that aggregates insight labels into holistic findings per identity, application, or business role, complete with impact explanations and remediation workflows.

7. The method according to claim 1 wherein a machine-learning pipeline ingests organizational location, privilege envelope, and accessibility-graph features and assigns every resource a Very-Low to Very-High sensitivity tier, enabling precise risk evaluation of resources that are independent of manual tagging.

8. The method according to claim 1 wherein the model incorporates an active-learning feedback loop whereby administrator edits to resource-sensitivity labels are stored as training data and used to retrain the classifier, yielding progressively higher accuracy without full retraining cycles.

9. The method according to claim 1 wherein tenant-configurable confidence thresholds allow each organization to fine-tune sensitivity and role confidence thresholds; deviations from these thresholds instantly spawn findings whose risk weights scale with the size of the deviation, ensuring that the most anomalous privileges rise to the top of remediation queues.

10. The method according to claim 1 wherein the method operates in a zero-touch mode, requiring customers only to connect integrations; the system harvests entitlements, synthesizes RBAC, and presents prioritized recommendations without manual rule-writing unless preferred by the organization.
